(19) United States
(12) Patent Application Publication
(10) Pub. No.: US 2026/0297973 A1
(43) Pub. Date: Oct. 1, 2026

(54) SYSTEM FOR ASSEMBLING LOAD-BEARING FRAME OF HIGH-RISE STRUCTURE

(71) Applicants: Ruslan Sokolov, Ingolstadt (DE); Peter Kropotin, Almaty (KZ)

(72) Inventors: Ruslan Sokolov, Ingolstadt (DE); Peter Kropotin, Almaty (KZ)

(21) Appl. No.: 19/091,347

(22) Filed: Mar. 26, 2025

(51) Int. Cl. E04H 12/34; E04H 12/00; E04H 12/10; F03D 13/10

(52) U.S. Cl. CPC E04H 12/344; E04H 12/10; F03D 13/112; E04H 2012/006; F05B 2230/61

(57) ABSTRACT

Systems and methods for assembling a load-bearing frame of a high-rise structure are provided. The system has a foundation configured to support the load-bearing frame. Additionally, the system is provided with a plurality of columns. At least one column of the plurality of columns is connected with an adjacent column of the plurality of columns via at least one beam. The system has a lifting assembly having a carcass with plurality of posts. The system has a fixture rigidly connected to the foundation and configured to anchor the plurality of columns during assembly of the load-bearing frame. The lifting assembly vertically displaces the plurality of columns to allow placement of an additional plurality of columns under the vertically displaced plurality of columns.

### TECHNICAL FIELD

The present disclosure generally relates to the construction of load-bearing structures. More specifically, the present disclosure relates to a system for assembling a load-bearing frame of high-rise structures.

### BACKGROUND

Energy generation from renewable energy sources continues to be in demand. However, renewable energy sources, such as wind power systems, rely on a height of the towers to increase energy production. For example, from 2002 to 2022, the average hub height increased by 25%, while the turbine power capacity grew by 2.5 times. Investments in increased tower height can yield very high rates of return in power production.

The power of wind turbine units is growing from year to year, because this is the most effective way to reduce the cost of generating electricity. Increasing power, in turn, is difficult to achieve without increasing the size, in particular, the height of the tower.

High altitudes have the most stable and powerful winds. The higher the altitude, the less dependent the wind behavior is on the terrain. Thus, the installation of wind generators at high altitudes makes it possible to produce wind energy even in areas with weak winds.

There is, therefore, a need for a system that allows to assemble towers with increased height without regard to a particular terrain and without increasing the cost of manufacturing and assembly of the wind turbine generators.

Moreover, there is a need for systems that can be constructed in an expeditious and cost-effective manner to meet the ever-expanding demand for renewable energy.

### SUMMARY

In one aspect, the present invention provides a system for assembling a load-bearing frame of a high-rise structure. The system has a foundation with embedded parts configured to support the load-bearing frame. Additionally, the system is provided with a plurality of columns. At least one column of the plurality of columns is connected with an adjacent column of the plurality of columns via at least one beam. The system has a lifting assembly having a carcass with plurality of posts. The system has a fixture rigidly connected to the foundation and configured to anchor the plurality of columns during assembly of the load-bearing frame. The lifting assembly vertically displaces the plurality of columns to thereby allow placement of an additional plurality of columns under the vertically displaced plurality of columns.

In another aspect, the present invention provides a tier-based system for assembly of a load-bearing frame. The system has at least one tier. The tier has a plurality of columns, and at least one column of the plurality of columns is configured to be connected with an adjacent column of the plurality of columns via at least one beam. The system further includes at least one lifting assembly configured to vertically displace the at least one tier and allow placement of at least one additional tier under the vertically displaced at least one tier.

In yet another aspect, the present invention provides a method for assembling a load-bearing frame of a high-rise structure. The method includes providing a foundation including embedded parts and configured to fixedly connect the load-bearing frame to the foundation, for example, using welding, bolts, rivets, or another type of connection. The method further includes providing a lifting assembly comprising a carcass with plurality of posts and connecting the posts of the plurality of posts with the embedded parts of the foundation via a plurality of fasteners. The lifting assembly is configured to vertically displace the at least one column of the plurality of columns. The method further includes a fixture rigidly connected to the foundation and configured to anchor the plurality of columns during assembly of the load-bearing frame. The method further includes providing a plurality of columns. At least one column of the plurality of columns is connected with an adjacent column of the plurality of columns via at least one beam. The method further includes vertically displacing the plurality of columns to allow placement of an additional plurality of columns under the vertically displaced plurality of columns.

### BRIEF DESCRIPTION OF THE DRAWINGS

In order that the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, aspects of the invention will be described and explained with additional specificity and detail through the use of the accompanying drawings.

FIG. 1 depicts a diagram of a foundation of a system for assembling a load-bearing frame of high-rise structures according to embodiments of the present invention;

FIG. 2 depicts a diagram of a carcass of a lifting assembly of the system according to embodiments of the present invention;

FIG. 3 depicts a diagram of a fixture of the lifting assembly of the system according to embodiments of the present invention;

FIG. 4 depicts a diagram of a frame of the lifting assembly of the system according to embodiments of the present invention;

FIG. 5 depicts a diagram of a lifting assembly of the system according to embodiments of the present invention;

FIG. 6 depicts diagram of a step of assembly of the load-bearing frame according to embodiments of the present invention;

FIG. 7 depicts a diagram of another step of assembly of the load-bearing frame according to embodiments of the present invention;

FIG. 8 depicts a diagram of another step of assembly of the load-bearing frame according to embodiments of the present invention;

FIG. 9 depicts a diagram of another step of assembly of the load-bearing frame according to embodiments of the present invention;

FIG. 10 depicts a diagram of another step of assembly of the load-bearing frame according to embodiments of the present invention;

FIG. 11 depicts a diagram of another step of assembly of the load-bearing frame according to embodiments of the present invention;

FIG. 12 depicts a diagram of another step of assembly of the load-bearing frame according to embodiments of the present invention;

FIG. 13 depicts a diagram of another step of assembly of the load-bearing frame according to embodiments of the present invention;

FIG. 14 depicts a diagram of the load-bearing frame assembled and the frame of the lifting assembly still in place according to embodiments of the present invention;

FIG. 15 depicts a diagram of the load-bearing frame assembled and the frame of the lifting assembly having been removed according to embodiments of the present invention;

FIG. 16 depicts a diagram of the load-bearing frame assembled according to embodiments of the present invention; and

FIG. 17 depicts a diagram of the load-bearing frame assembled according to embodiments of the present invention.

FIG. 18 depicts a diagram of a foundation of a system for assembling a load-bearing frame of high-rise structures according to embodiments of the present invention;

FIG. 19 depicts a diagram of the foundation of FIG. 18, showing supports that support the load from the fixture onto the foundation according to embodiments of the present invention;

FIG. 20 depicts a diagram of the foundation of FIG. 19, showing rail members installed on the supports according to embodiments of the present invention;

FIG. 21 depicts a diagram of a stand configured to be movably coupled to the rail members of the foundation depicted in FIG. 20 according to embodiments of the present invention;

FIG. 22 depicts a diagram, showing four stands movably coupled to the rail members positioned on the foundation of FIG. 20 depicted according to embodiments of the present invention;

FIG. 23 depicts a diagram of a frame configured to be movably coupled to a post and to secure a column supported on the foundation in position according to embodiments of the present invention;

FIG. 24 depicts a post, showing the frame of FIG. 23 movably coupled to the post according to embodiments of the present invention;

FIG. 25 depicts a diagram of a lifting assembly in its fully assembled state that includes the foundation of FIG. 22 and four posts of FIG. 24 coupled to the foundation according to embodiments of the present invention;

FIG. 26 depicts a diagram of a first step of assembly of a lattice tower using the lifting assembly of FIG. 25 according to embodiments of the present invention, showing the lattice tower being placed onto the stands of the lifting assembly and showing the posts in their inactive position;

FIG. 27 depicts a diagram of another step of the assembly of the lattice tower using the lifting assembly of FIG. 25 according to embodiments of the present invention, showing the posts in their deployed position where the frames of the posts engage the lattice tower;

FIG. 28 depicts a diagram of another step of the assembly of the lattice tower using the lifting assembly of FIG. 25 according to embodiments of the present invention, showing the posts in an intermediate position located between the inactive position and the deployed position;

FIG. 29 depicts a diagram of another step of the assembly of the lattice tower using the lifting assembly of FIG. 25 according to embodiments of the present invention, showing the columns after the lifting assembly lifts the first tier of the columns and beams of the lattice tower from the ground level of FIG. 28 to the next level located higher up from the ground level;

FIG. 30 depicts a diagram of another step of the assembly of the lattice tower using the lifting assembly of FIG. 25 according to embodiments of the present invention, showing a second tier of columns and beams being mounted onto the lifting assembly into the space created by the movement of the first tier from the ground level to the next level up;

FIG. 31 depicts a diagram of another step of the assembly of the lattice tower using the lifting assembly of FIG. 25 according to embodiments of the present invention, showing the first tier lowered onto and secured to the second tier to increase the overall height of the lattice tower;

FIG. 32 shows a portion of an assembled lattice tower installed on the foundation according to embodiments of the present invention, showing the lattice tower after the lifting assembly is disassembled and removed.

### DETAILED DESCRIPTION

Reference to “a specific embodiment” or a similar expression in the specification means that specific features, structures, or characteristics described in the specific embodiments are included in at least one specific embodiment of the present invention. Hence, the wording “in a specific embodiment” or a similar expression in this specification does not necessarily refer to the same specific embodiment.

Hereinafter, various embodiments of the present invention will be described in more detail with reference to the accompanying drawings. Nevertheless, it should be understood that the present invention could be modified by those skilled in the art in accordance with the following description to achieve the excellent results of the present invention. Therefore, the following description shall be considered as a pervasive and explanatory description related to the present invention for those skilled in the art, not intended to limit the claims of the present invention.

Reference to “an embodiment,” “a certain embodiment” or a similar expression in the specification means that related features, structures, or characteristics described in the embodiment are included in at least one embodiment of the present invention. Hence, the wording “in an embodiment,” “in a certain embodiment” or a similar expression in this specification does not necessarily refer to the same specific embodiment.

Embodiments of a system for assembling a load-bearing frame of high-rise structures, such as a wind turbine generators are described herein. Conventional modern electric power systems that rely on energy generation from renewable energy sources (RES), such as wind turbine generators face challenges due to their inherent unpredictability and unreliability due to their reliance on weather and terrain conditions.

As mentioned above, wind power systems rely on the height of the towers to increase energy production. At high altitudes, stable and powerful winds prevail, and the higher the altitude, the less dependent the wind behavior is on the terrain. Thus, the installation of wind generators at high altitudes makes it possible to produce wind energy even in areas with weak winds.

Investments in increased tower height can yield very high rates of return in power production. For example, according to the logarithmic wind profile law, increasing the hub height from 100 to 140 meters on relatively flat terrain increases the wind generator's output by approximately 25%.

In the case of wind turbine generators, it is often desirable to assemble towers over a hundred (100 m) meters high. For such a height, the most common tower construction technology today is tubular steel, which has a number of limitations. First, diameters of tower sections are generally limited to 4.3 meters (or 4.6 meters in some cases) to ensure their safe movement under overhead obstructions. Second, installation of elements of this scale at a height of 100 meters requires the participation of highly qualified and expensive specialists. Third, for assembling towers using tubular steel technology requires construction cranes that are taller than the height of the tower, which makes these cranes specifically adapted to operating at high altitudes (the weight of one tubular section of steel can exceed 100 tons). All three restrictions become even more challenging if the height of the wind turbine tower exceeds 100 meters. Embodiments of the present invention advantageously address, and, in many instances, remove all three restrictions, and make it possible to expedite the assembly of the wind turbine generator towers and to substantially reduce the cost of the construction of wind turbine generators.

Thus, the need to increase the tower height of wind turbine generators is the key principle to generate more electrical power from the wind energy. However, the limitations of tubular steel technology hinder the increase of the tower height a large scale. In particular, this was demonstrated by a numerical assessment of the increase in the cost of towers built from tubular steel. The increase of tubular steel towers from 100 to 120 meters leads to an increase in capital costs by at least two times, and from 100 to 140 meters-more than 3.5 times, which significantly affects the overall value of the entire wind power plant. The latter can be concluded since, at a height of about 100 meters, the cost of a tower construction, along with assembly and installation, is about 16% of the cost of the entire project.

Embodiments of the system according to the present invention allow assembly of lattice towers for wind turbine generators from elements that, in terms of their size, conform to all the necessary logistics restrictions. The entire tower assembly process advantageously takes place at a ground level without necessitating highly skilled work. As a result, there is no need for unique construction cranes, the height of which exceeds the height of the wind generator tower.

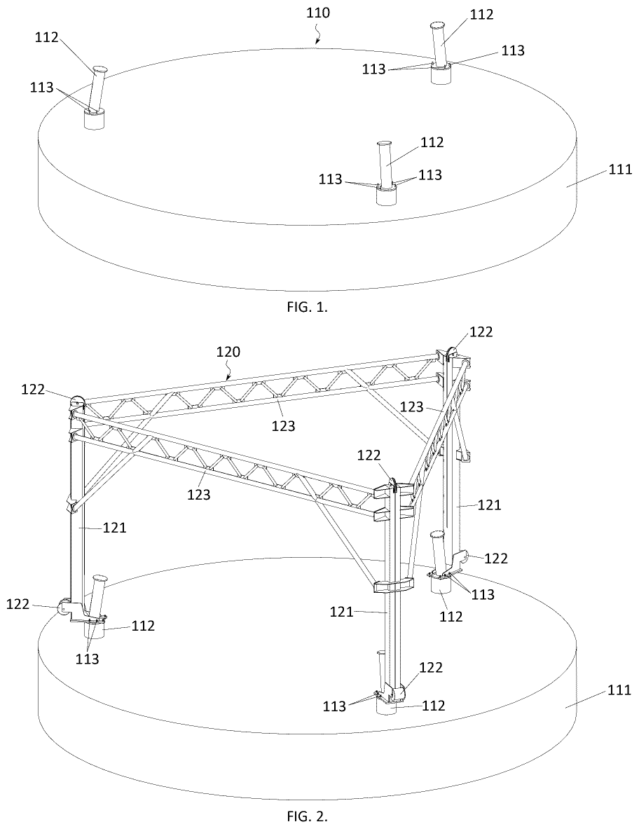

An embodiment of a system 100 for assembling a load-bearing frame of high-rise structures is illustrated in FIGS. 1-17 and described below in more detail. It should be understood that while the system 100 is described using the example of lattice towers 160 for wind turbine generators, the system 100 and methods described in this disclosure are applicable to any system that requires an assembly of high-rise structures.

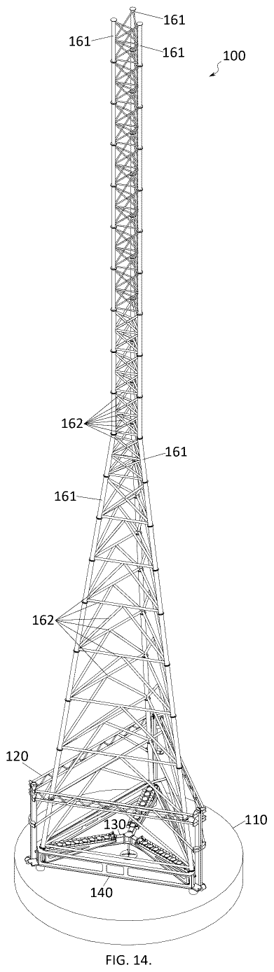

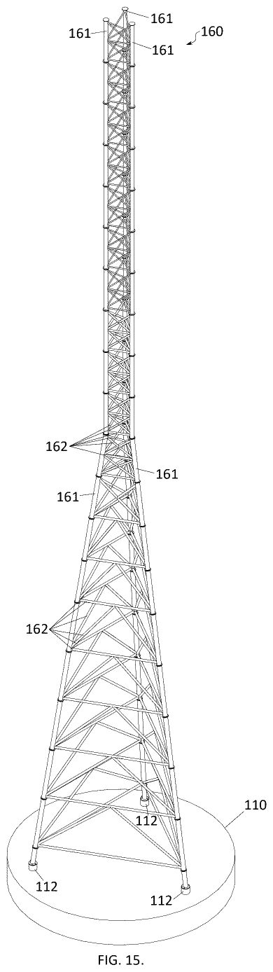

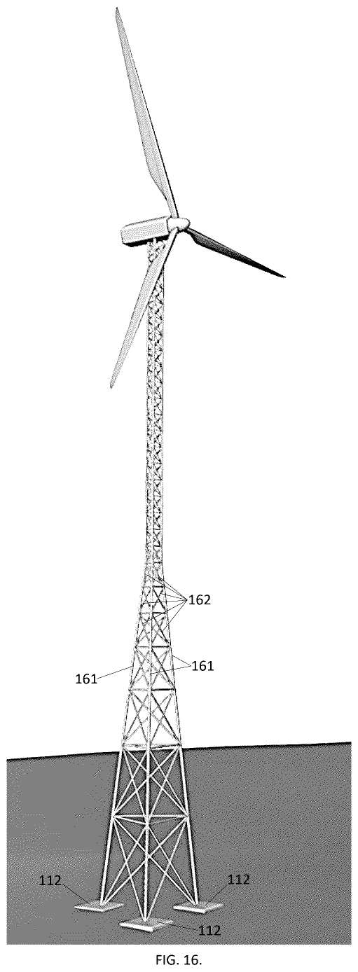

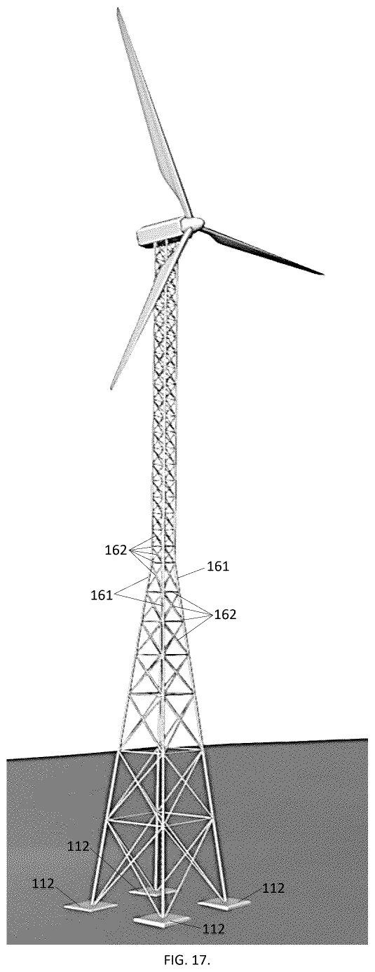

As illustrated in FIG. 1, the system 100 (shown with an assembled lattice tower 160 in FIG. 14) is provided with a foundation 110. The foundation 110 can have a circular pedestal 111 for supporting columns 161 (shown in FIGS. 6-16) of a lattice tower 160 (shown in FIG. 15) for a wind turbine generator (shown in FIGS. 16-17). The foundation 110 can be formed from concrete or combination of concrete and other elements, such as reinforced bars and piles. In some aspects, the foundation 110 can have embedding fasteners, for example, column shoes 112, to securely attach the lattice tower 160 of the wind turbine generator to the foundation 110.

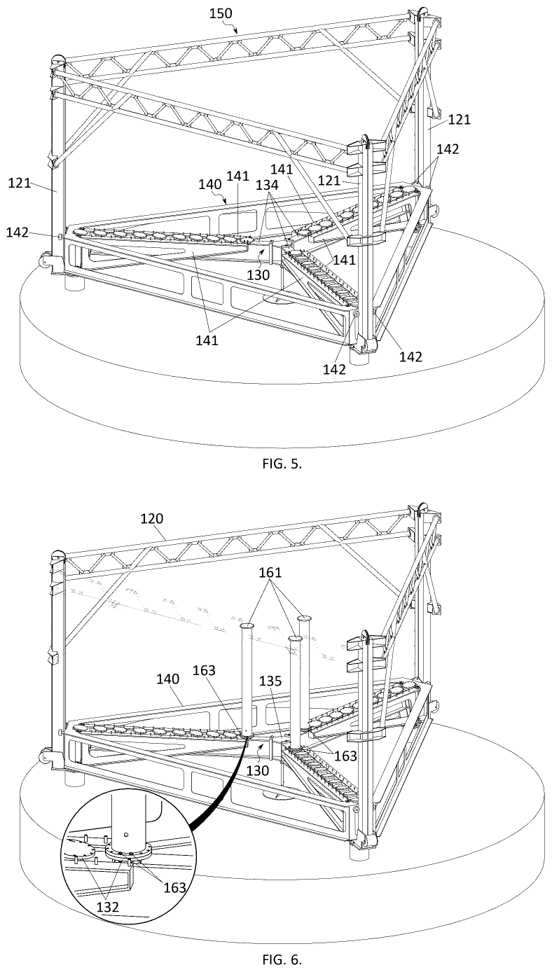

The system 100 is further provided with a lifting assembly 150 (shown in FIG. 5). The lifting assembly 150 can have a carcass 120 as shown in FIGS. 2 and 5. As shown in FIG. 2, the carcass 120 may include posts 121 connected by frames 123 for added stability. Each post 121 can be provided with pulleys 122. Each post 121 may be attached to a shoe 112 using one or more fasteners 113. The column shoes 112 may be fixedly attached to (e.g., embedded into) the circular pedestal 111 of the foundation 110.

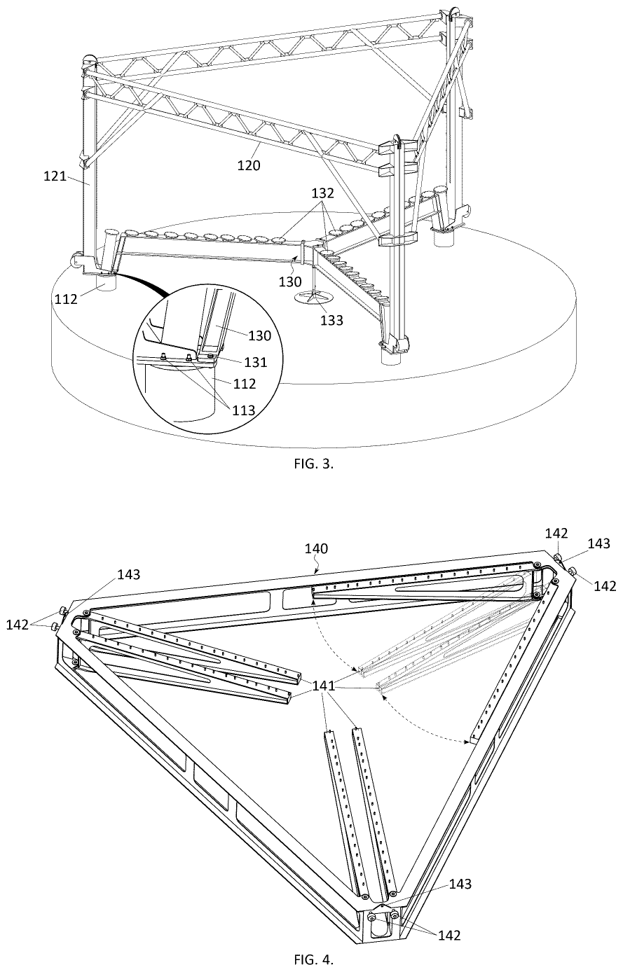

FIG. 3 further shows a fixture 130 of lifting assembly 150. In the illustrated embodiment, the fixture 130 is rigidly attached to the column shoes 112 of the foundation 110 through the posts 121 using fasteners 131. As shown in FIG. 3, the fixture 130 may have stands 132 for precise positioning of the structural elements of the lattice tower 160 during the assembly process, as well as a thrust screw 133 for level adjustment of the fixture 130.

FIG. 3 also illustrates the carcass 120 of lifting assembly 150. In particular, the expanded view of FIG. 3 shows the fasteners 113 that may be used to attach the posts 121 to the column shoes 112 in accordance with an embodiment of the present invention.

As illustrated in FIG. 4, according to embodiments of the present invention, a frame 140 of the lifting assembly 150 can be equipped with folding supports 141, guide rollers 142 that guide the frame along the posts 121 and openings 143. While the guide rollers 142 are not yet attached to the frame 140, the frame 140 can be placed inside the carcass 120 so that the folding supports 141 are oriented along the ribs 134 of the fixture 130 (as shown in FIG. 5). Subsequently, using fasteners (not shown), the guide rollers 142 are fixed into the frame 140 so that the guide rollers 142 are located proximate to the posts 121 (as shown in FIG. 5).

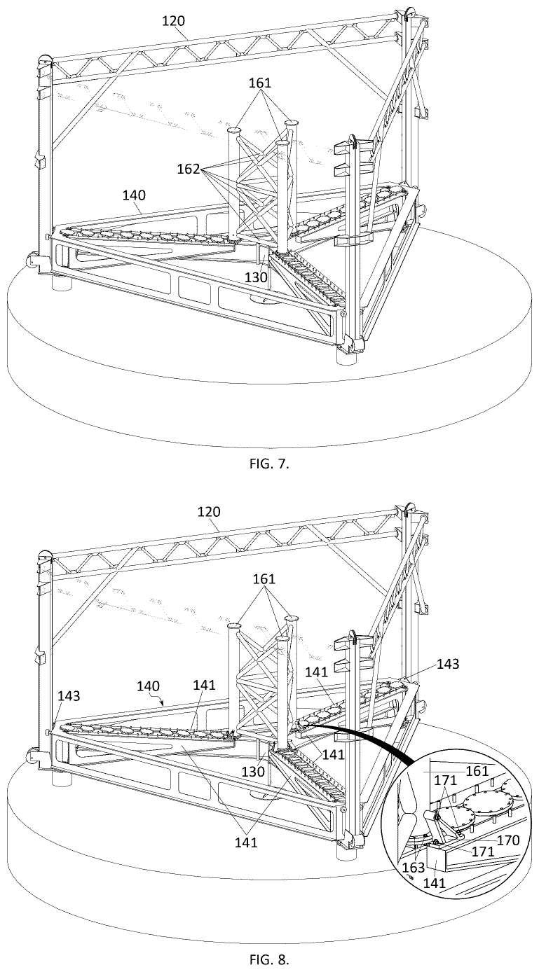

FIGS. 6 and 7 illustrate the initial steps of the assembly of a lattice tower 160 (shown fully assembled in FIG. 15) of high-rise structures for the wind turbine generator, according to embodiments of the present invention. With reference to FIG. 6, metal columns 161 are rigidly attached to stands 132 of a fixture 130, closest to a center hub 135 of the fixture 130 from which the three ribs 134 of the fixture 130 extend, for example, using bolted connections 163 (as shown in the close-up view of FIG. 6). In the embodiment illustrated in FIG. 7, the rigidity of the resulting structure is improved, for example, by welding the columns 161 together with the beams 162.

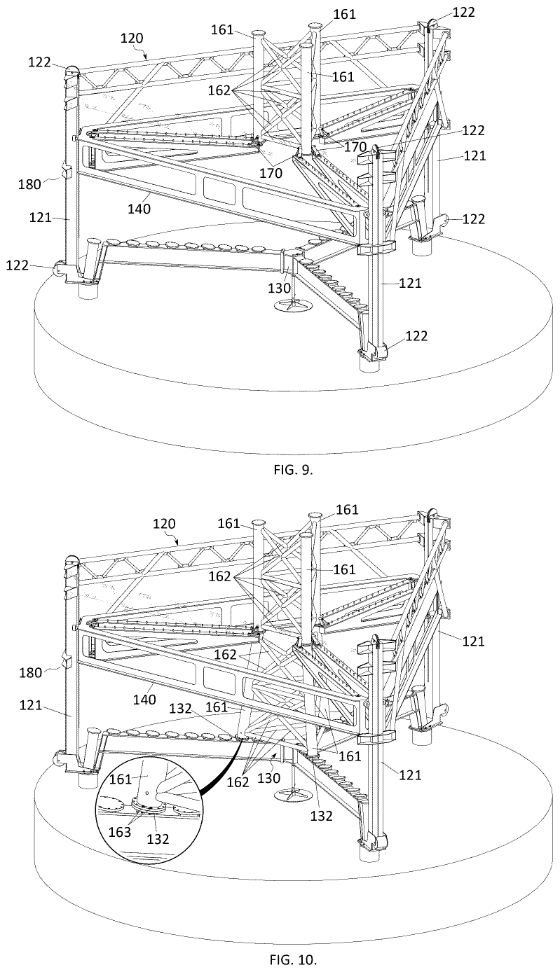

In the embodiments illustrated in FIGS. 8 and 9, the columns 161 are attached to the folding supports 141 of the frame 140 using holders 170 and bolted connections 171. The columns 161 may be disconnected from the fixture 130 by releasing the bolted connections 163 (as shown in the close-up image of FIG. 8).

In the embodiments illustrated in FIGS. 8 and 9, the frame 140 is attached through the openings 143 to pulleys 122, for example, by a rope. The lifting assembly 150 can have corresponding ropes threaded through the pulleys 122. The pulleys 122 with their respective ropes are used to elevate the frame 140 together with the columns 161 and beams 162, up to a level 180, just above the level required for installing the columns of a next tier (as shown in FIG. 9).

The next possible step of assembling the lattice tower 160 is illustrated in FIG. 10. As shown in FIG. 10, the columns 161 are mounted to the second stands 132 closest to the center hub 135 of the fixture 130 using bolted connections 163 and fastened to each other with the beams 162, for example, by welding (as shown in the close up in FIG. 10). The frame 140, together with the columns 161 and beams 162, mounted in the previous step, is lowered until the columns 161 are joined in a vertical plane and rigidly connected to each other, for example, by fasteners such as bolts.

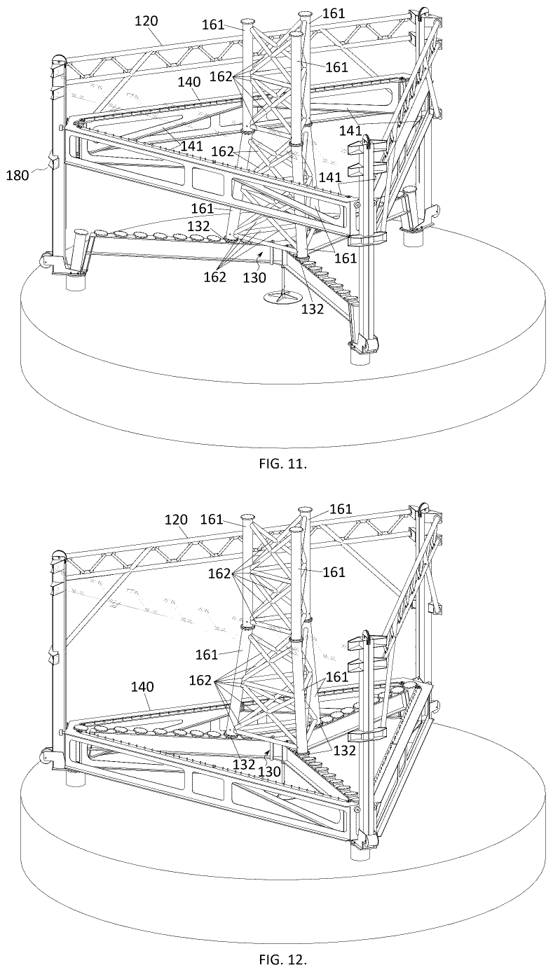

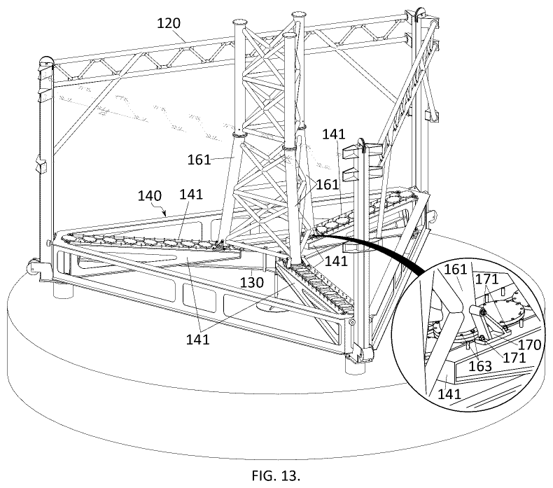

In some embodiments, in order to release the frame 140, the holders 170 are removed using bolted connections 171 and the folding supports 141 are opened (as shown in FIG. 11). The frame 140 is then lowered to its original position on the fixture 130 (as shown in FIG. 12. The folding supports 141 are then closed along the fixture 130 (as shown in FIG. 13). Then, holders 170 are installed and columns 161 are disconnected from the fixture 130 by releasing the bolted connections 163 (as shown in FIG. 13).

The remaining tiers of columns 161 and beams 162 are assembled into the lattice tower 160 by repeating the assembly method described above (and shown in FIG. 9 to FIG. 13). Once all columns 161 and beams 162 of the system 100 are assembled to form a fully assembled lattice tower 160, as shown in FIG. 14, the lifting assembly 150 may be dismantled and removed. FIG. 15 illustrates the lattice tower 160 after the lifting assembly 150 is dismantled and removed from the foundation 110.

It will be appreciated that the inclination of the columns 161 depends on the design of the stands 132 of the fixture 130. Lattice towers 160 with a variable horizontal cross-section can be erected in the manner described in FIGS. 1-15, and are shown, by way of example, in FIG. 16 and FIG. 17. The number of ribs 134 of the fixture 130 and frame 140, as well as the number of posts 121 determines the number of angles of the horizontal cross section of the lattice tower 160. For example, if the fixture 130 has four ribs 134 instead of three, and four posts 121 are used in the structure of the carcass 120, then a quadrangular tower can be assembled as shown in FIG. 17. In other words, the system 100 allows the assembly of the lattice towers 160 having the various number of vertexes in horizontal cross-section.

Further, the lifting assembly 150 can be provided with a propulsion drive (not shown), which can be local or remote and implemented in the form of a winch that is built into the carcass 120 or positioned in proximity to the carcass 120. The design of the propulsion drive can be hydraulic, chain, screw or other.

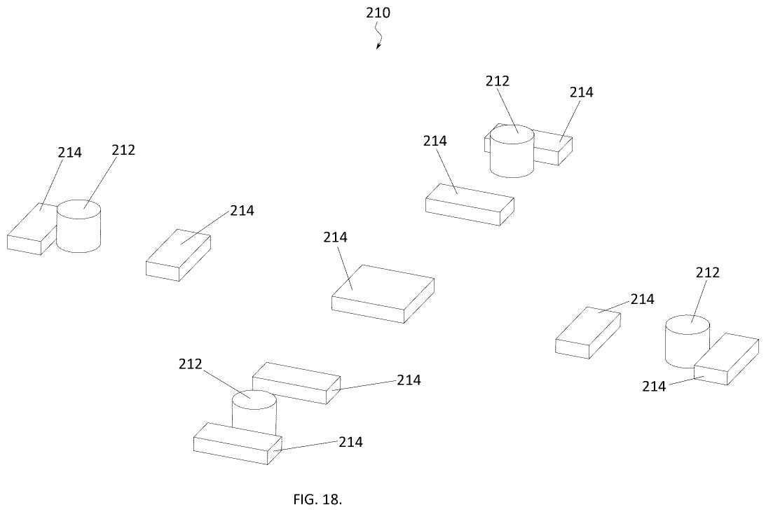

An embodiment of a system 200 for assembling a load-bearing frame of high-rise structures is illustrated in FIGS. 18-32 and described below in more detail. It should be understood that while the system 200 is described using the example of lattice towers for wind turbine generators, the system 200 and methods described in this disclosure are applicable to any system that requires an assembly of high-rise structures.

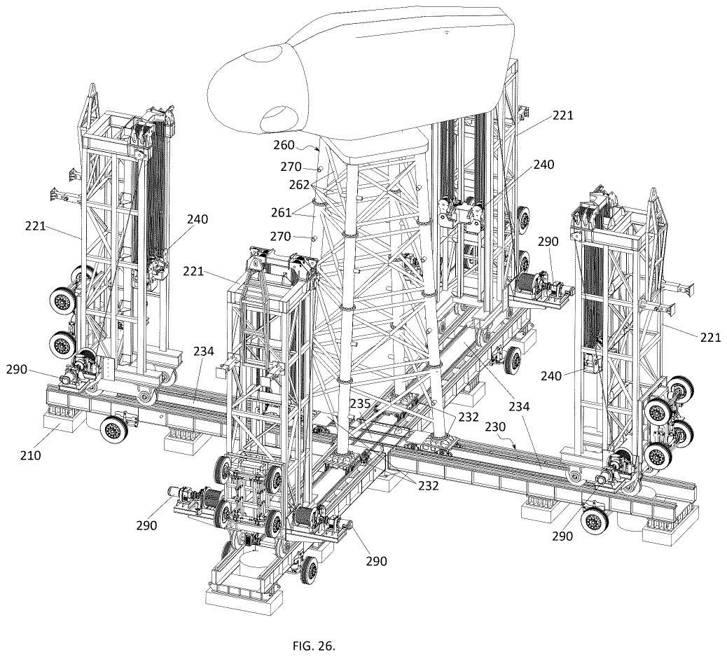

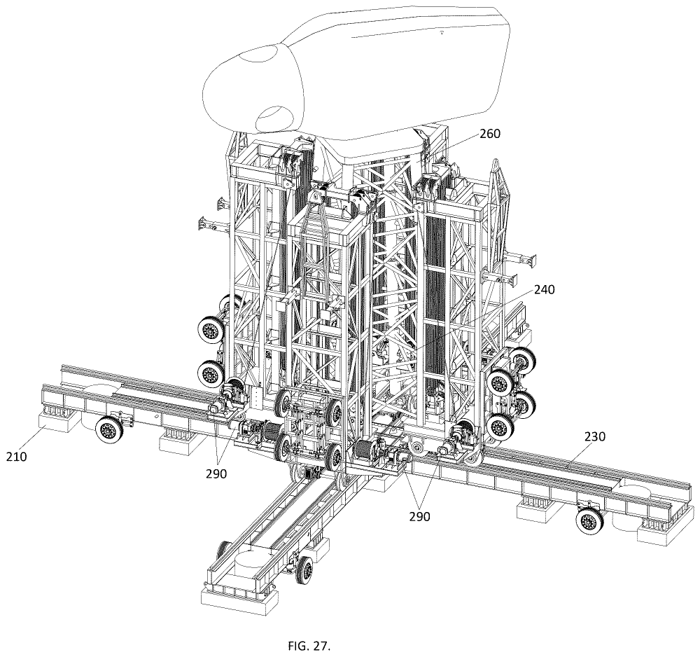

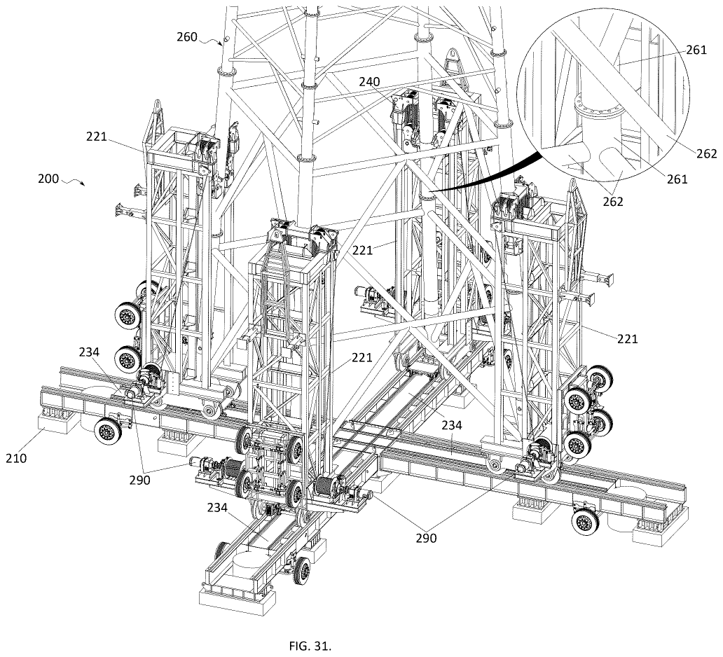

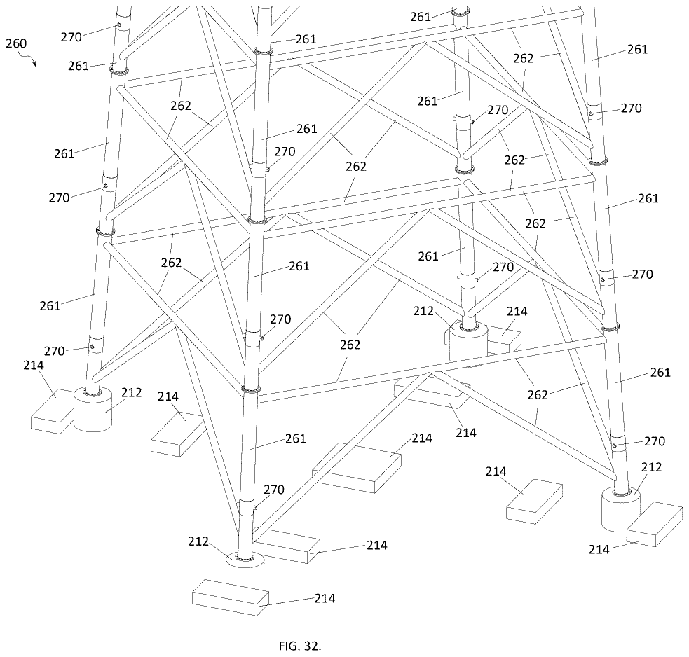

As illustrated in FIG. 18, the system 200 (shown in a partially assembled state in FIG. 31) is provided with a foundation 210. In an optional embodiment, the foundation 210 can have a circular or non-circular pedestal (akin to the circular pedestal 111 shown in FIG. 1) for supporting columns 261 (shown in FIGS. 26-32) of a lattice tower 260 (shown in part in FIG. 32) for a wind turbine generator (shown in FIGS. 16-17). The foundation 210 can be formed from concrete or combination of concrete and other elements, such as reinforced bars and piles. In some aspects, the foundation 210 can have embedding fasteners, for example, column shoes 212, to securely attach the lattice tower 260 of the wind turbine generator to the foundation 210.

In the embodiment illustrated in FIG. 18, the system 200 (shown with a partially assembled lattice tower 260 in FIG. 32) is provided with a foundation 210. Unlike the foundation 110 shown in FIG. 1, the foundation 210 does not include a circular pedestal akin to the circular pedestal 111 shown in FIG. 1. Instead, in the embodiment shown in FIG. 18, the foundation 210 includes several spaced apart column shoes 212 for supporting the columns 261 (shown in FIGS. 26-32) of a lattice tower 260 (shown in part in FIG. 32) for a wind turbine generator (shown in FIGS. 16-17). The foundation 210 can be formed from concrete or combination of concrete and other elements, such as reinforced bars and piles to securely attach the lattice tower 260 of, for example, a wind turbine generator, to the foundation 210. In the illustrated embodiment, the foundation 210 includes four column shoes 212, but it will be appreciated that more or less than four column shoes 212 may be used in other embodiments to assemble lattice towers 260 of various different shapes.

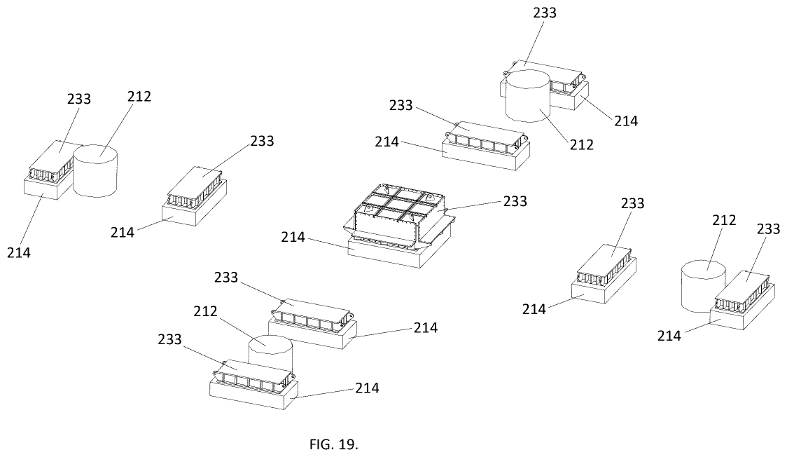

In some embodiments, the foundation 210 further includes several spaced apart support bases 214 that facilitate the installation of the fixture 230, which will be discussed in more detail below. In the embodiment illustrated in FIG. 18, the foundation includes one pair of support bases 214 adjacent each one of the column shoes 212, with one of the support bases 214 of the pair being located on one side of its respective column shoe 212, and the other of the support bases 214 of the pair being located on an opposite side of its respective column shoe 212. In some aspects, the foundation 210 further includes a support base 214 that is positioned centrally relative to the pairs of support bases 214 positioned adjacent the column shoes 212, and this support base 214 is larger in size than any of the other support bases 214, as shown in FIG. 19. In the embodiment shown in FIG. 9, the foundation 210 includes nine support bases 214 (i.e., four pairs of support base 214 and one single, centrally positioned support base 214), but it will be appreciated that more or less nine support bases 214 may be used in other embodiments to assemble lattice towers 260 of various different shapes.

In some embodiments, the support bases 214 include supports 233 to facilitate the distribution of the load from the fixture 230 to the foundation 210 via the support bases 214. The supports 233 may freely rest on the support bases 214, or may be attached to the support bases 214 via one or more fastener or via an adhesive material, or the support bases 214 may be formed as a single unitary structure including the supports 233. In the embodiment illustrated in FIG. 19, each of the support bases 214 includes a support 233 coupled thereto, such that the foundation 210 includes nine support bases 214 and nine supports 233.

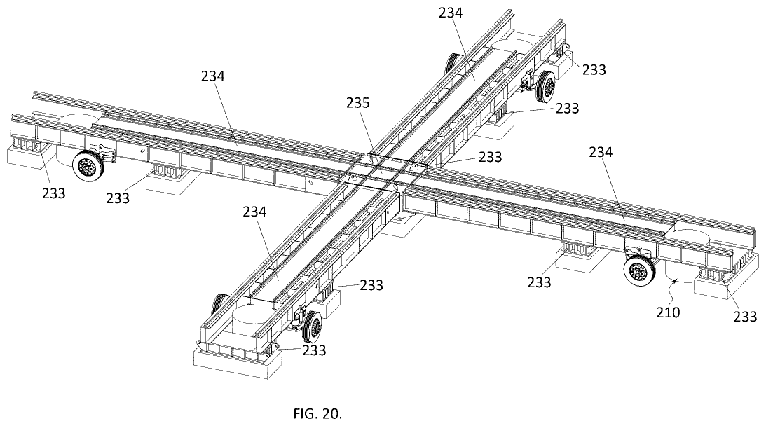

In the embodiment illustrated in FIGS. 20-31, in addition to the foundation 210, the system 200 includes a lifting assembly 250, components of which will be described in more detail below. In some aspects, the lifting assembly 250 includes a fixture 230, which is positioned on and supported by the support bases 214 and supports 233. In the embodiment illustrated in FIG. 20, the fixture 230 includes four rail members 234 that are positioned to form an X-shape. In the example shown in FIG. 20, the four rail members 234 are (detachably or non-detachably) coupled to a center hub 235 (which is located on a support 233 coupled to a support base 214) and are positioned on and supported by the supports 233 of the foundation 210.

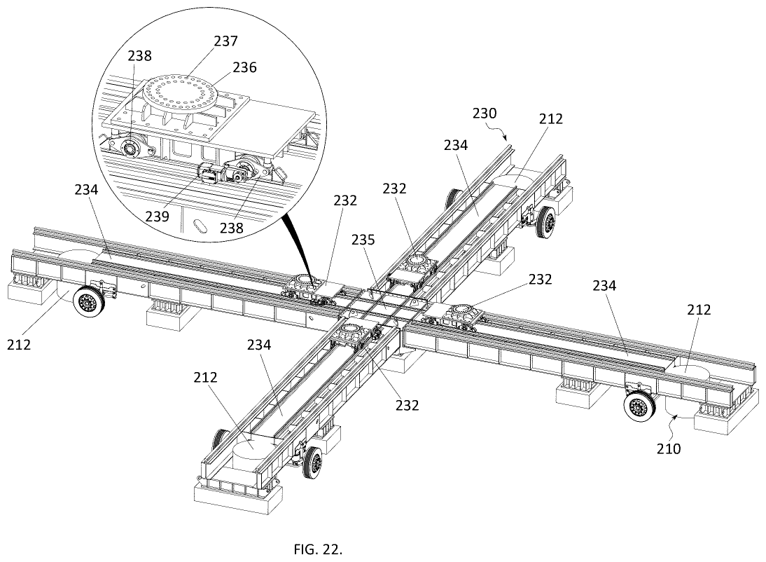

In some embodiments, the fixture 230 may include stands 232 coupled to the rail members 234, as shown in FIG. 22. In the illustrated embodiment, the stands 232 are coupled to the rail members 234 such that the stands are permitted to move along the rail members 234 between their resting position shown in FIG. 26 to their deployed position shown in FIG. 27. As shown, for example, in FIG. 26, each of the stands 232 is configured to couple to (and securely hold in place) the base of column 261 of a lattice tower 260.

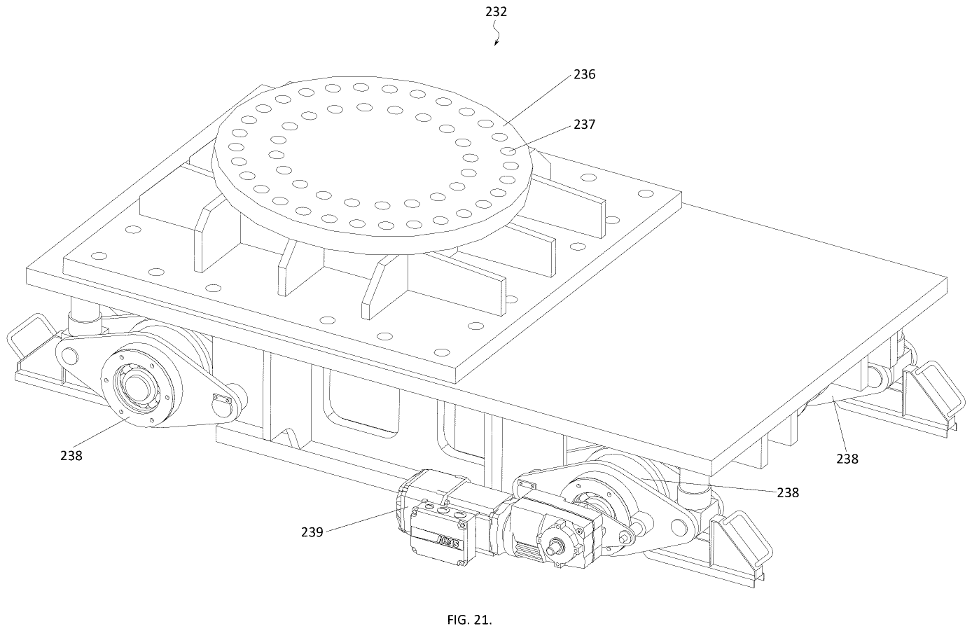

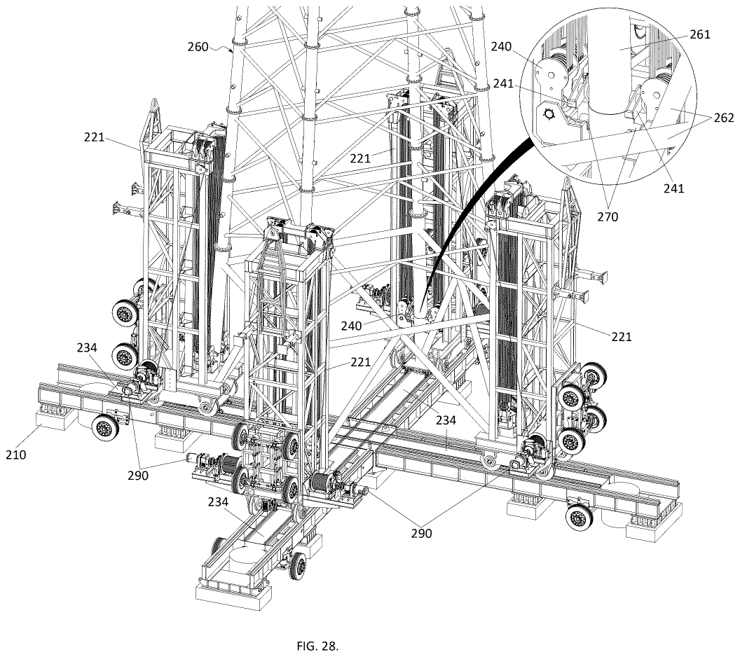

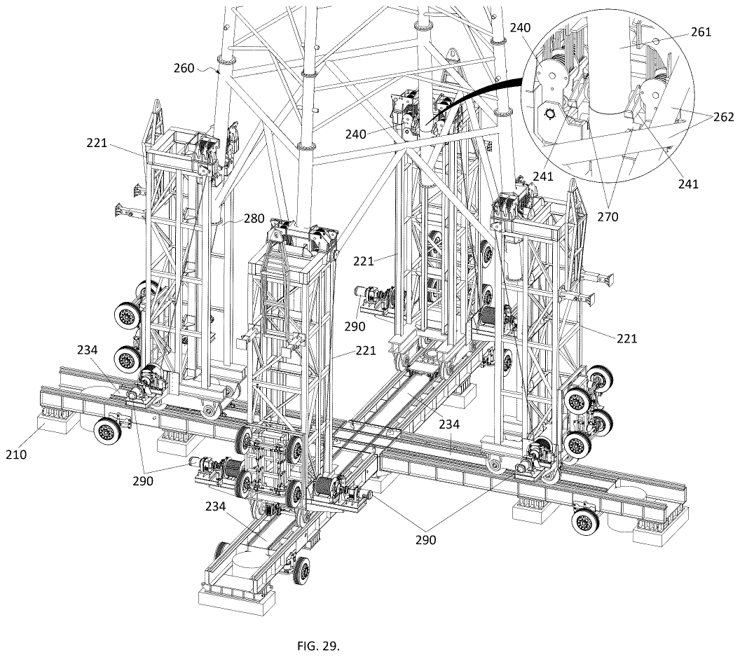

FIG. 21 shows the structure of an exemplary embodiment of a stand 232 in more detail. The stand 232 shown in FIG. 21 includes a platform 236 with a plurality of holes 237 for securing columns 261, as will be further shown in FIG. 26. In the illustrated embodiment, the stand 232 includes wheels 238 and a drive 239 to facilitate the movement of the stand 232 along a rail member 234 (between the resting position shown in FIG. 26, deployed position shown in FIG. 27, and intermediate position shown in FIG. 28) when the stand 232 is coupled to the rail member 234.

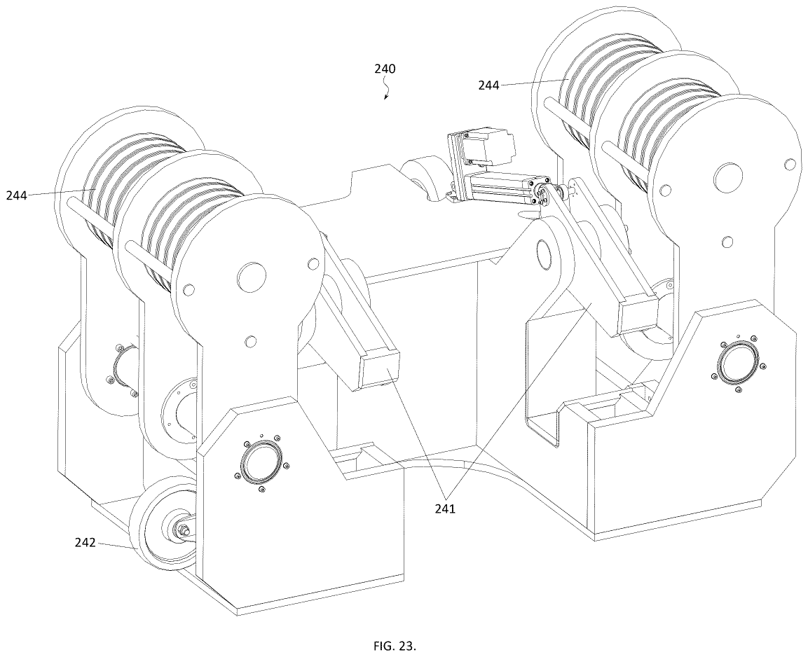

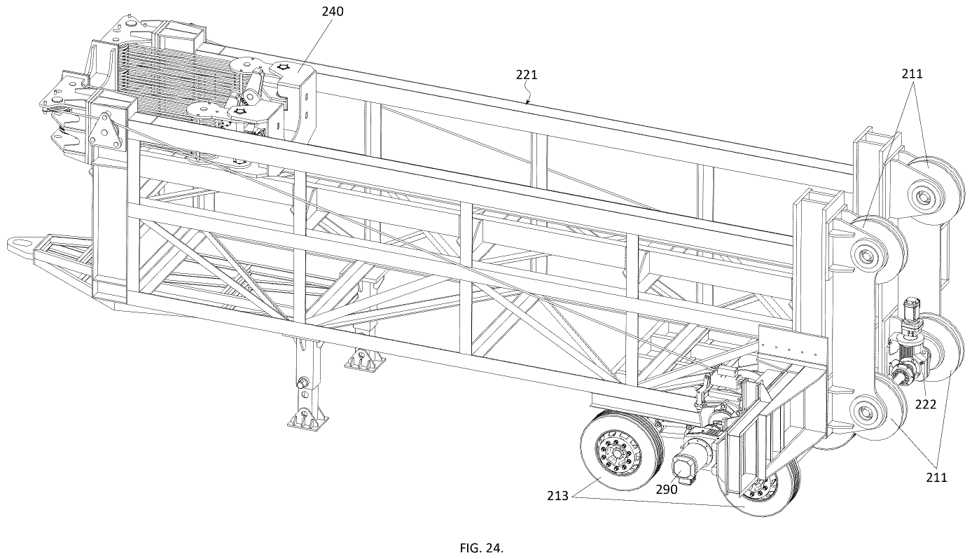

In the illustrated embodiment, the lifting assembly 250 further includes a frame 240 as shown in FIG. 23 that is configured to couple to a column 261 (as shown in FIG. 28) and to move up and down (together with the column 261) between a lowered position shown in FIG. 28 and the raised position shown in FIG. 29. In the embodiment shown in FIG. 23, the frame 240 includes movable blocks 244 and guide rollers 242 to permit the frame 240 to movably couple to and move relative to a post 221 (shown in FIG. 24). In some aspects, the frame 240 may include folding supports 241 for securing the column 261 with holders 270, as shown in more detail in FIG. 28.

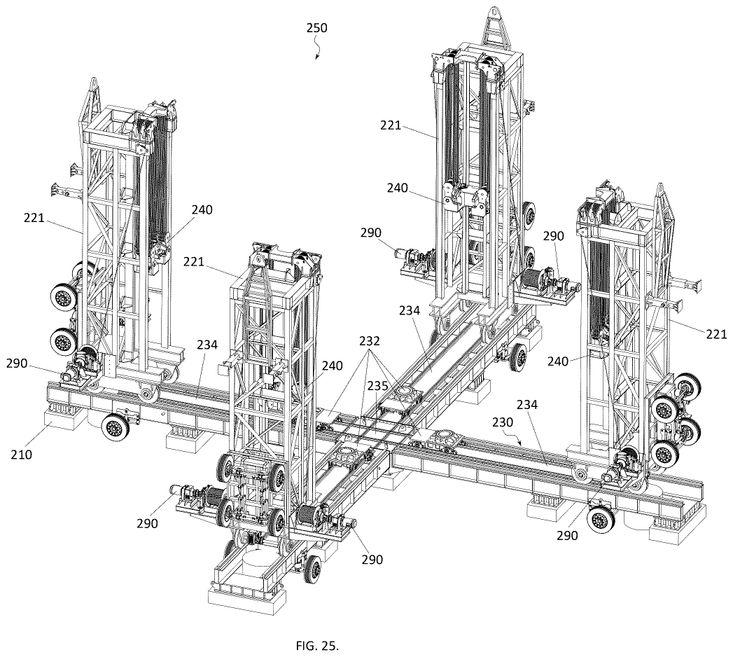

In the illustrated embodiment, the lifting assembly 250 further includes a post 221 as shown in FIG. 24. In the embodiment shown in FIG. 25, the lifting assembly 250 includes four posts 221, with each of the posts 221 including a frame 240 movably coupled thereto, such that the lifting assembly 250 includes four posts 221 and four frames 240. However, it will be appreciated that the lifting assembly 250 may include more or less than four posts 221 and frames 240 in some other embodiments.

FIG. 24 depicts an embodiment of a 221 to which a frame 240 is coupled such that the frame 240 is permitted to move along the post 221. In the illustrated embodiment, the post 221 includes wheels 211 and an active drive 222. In some aspects, when the post 221 is mounted on and coupled to a rail member 234 of the fixture 230, the wheels 211 and the active drive 222 enable the post 221 to move along the rail member 234 between the resting position shown in FIG. 26, deployed position shown in FIG. 27, and intermediate position shown in FIG. 28.

In the embodiment illustrated in FIG. 24, the 221 further includes a drive 290 (which may be a propulsion drive), which may use a cable coupled thereto to move the frame 240 along movable blocks 244. In the example shown in FIG. 24, the post 21 may also contain wheels 213 that permit the post 221 to be transported on roads by transport vehicles, e.g., as a trailer, to the location where the lattice tower 260 is to be assembled.

FIG. 25 shows an embodiment of the lifting assembly 250 in its fully assembled state and mounted on the foundation 210. When the lifting assembly 250 is in its fully assembled state, the system 200 is ready for assembly of a lattice tower 260 (as shown in FIGS. 26-31, with the end product of this assembly being an assembled lattice tower 260, a portion of which is shown in FIG. 32.

FIG. 26 illustrates an initial step of an exemplary method of assembly of a high-rise structure (e.g., a lattice tower 260 for a wind turbine generator). With reference to FIG. 26, columns 261 (which may be made from a material such as metal, concrete, etc.) are rigidly attached (e.g., via one or more fasteners) to the stands 232 of the fixture 230. In the embodiment illustrated in FIG. 26, each of the four stands 232 is attached to a respective one of the four columns 261 (as shown in FIG. 28) and positioned (e.g., via the drive 239 and/or movement of the wheels 238 along a rail member 234) adjacent to the center hub 235 of the fixture 230 from which the rail members 234 of the fixture 230 extend.

In some aspects, the beams 162 of the lattice tower 260 are rigidly attached to the columns 261 of the lattice tower 260, for example, by welding, fasteners or other suitable means. In FIG. 26, the columns 261 and beams 262 are the building blocks of the lattice tower 260 and form a first tier of the lattice tower 260.

FIG. 27 illustrates the next step of the exemplary method of assembly of the lattice tower 260. With reference to FIG. 27, the posts 221 are moved via the active drive 222 and/or movement of the wheels 211 along the rail members 234 (as described above) from their resting positions shown in FIG. 26 (where the posts 221 are further away from the center hub 235) to their deployed positions shown in FIG. 27 (where the posts 221 are closer to the center hub 235 (and, preferably, adjacent to and/or in direct contact with the center hub 235).

FIG. 28 illustrates the next step of the exemplary method of assembly of the lattice tower 260. With reference to FIG. 28, while the columns 261 are rigidly attached (e.g., via one or more fasteners) to the stands 232 of the fixture 230, the stands 232 are moved via the drive 239 and/or movement of the wheels 238 along their respective rail members 234 in a direction away from the center hub 235 of the fixture 230. This movement of the stands 232 causes the corresponding movement of the posts 221 in a direction away from the center hub 235 of the fixture 230 from the deployed position of the posts 221 shown in FIG. 27 to the intermediate position of the posts 221 shown in FIG. 28. This movement of the stands 232 and the posts 221 from the position shown in FIG. 27 to the position shown in FIG. 28 causes the columns 261 and beams 262 of the first tier of the lattice tower 260 to expand as shown in FIG. 28.

FIG. 29 illustrates the next step of the method of assembly of the lattice tower 260. With reference to FIG. 29, the first tier of assembled columns 261 and beams 262 is lifted via actuation of the drive 290 and movement of the frames 240 (via the movable blocks 244 and/or guide rollers 242) in an upwardly direction along their respective posts 221 while the columns 261 are coupled to the frames 240. In some embodiments, prior to the frames 240 lifting the columns 261 and beams 262 to the level 280 shown in FIG. 29, the columns 261 are detached (disconnected) from the stands 232.

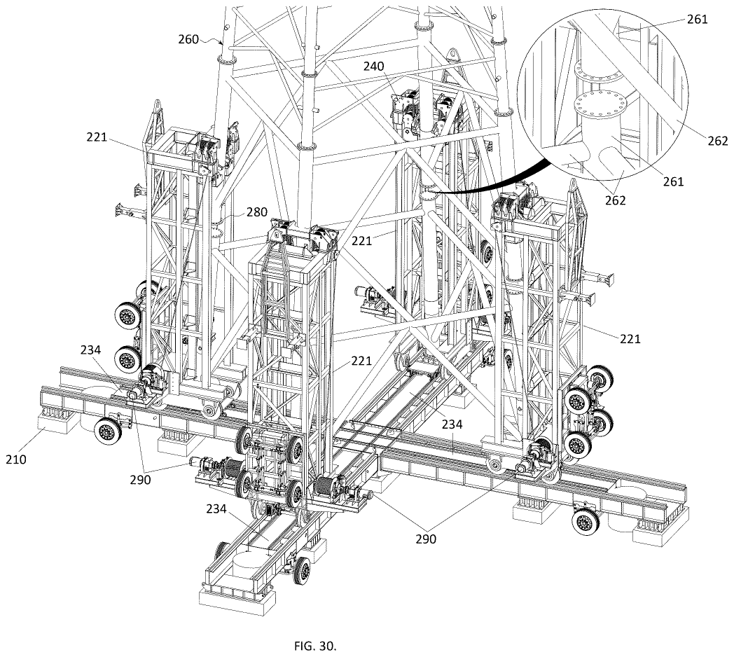

FIG. 30 illustrates the next step of the method of assembly of the lattice tower 260. Notably, when the first tier of columns 261 and beams 262 is lifted via the frames 240 and posts 221 of the lifting assembly 250 to the elevated level 280 shown in FIG. 29, the space left open by the now-lifted first tier permits the second tier of columns 261 and beams 262 to be inserted into this open space and mounted onto the lifting assembly 250. FIG. 30 shows the step of the method of assembly of the lattice tower 260 after the second tier of columns 261 and beams 262 are mounted onto the stands 232 as shown in FIG. 30 below the now-lifted first tier of columns 261 and beams 262, which then permits the second tier of columns 261 and beams 262 to be assembled and lifted up as described in more detail above in reference to the mounting and lifting of the first tier of columns 261 and beams 262 via the lifting assembly 250.

FIG. 31 illustrates the next step of the method of assembly of the lattice tower 260. In particular, after the columns 261 and beams 262 of the second tier are mounted onto the lifting assembly below the now-lifted first tier of columns 261 and beams 262, the first tier of columns 261 and beams 262 may be lowered via the frames 240 and posts 221 of the lifting assembly 250 onto the columns 261 and beams 262 of the second tier as shown in FIG. 31. After the first tier of columns 261 and beams 262 is lowered onto the columns 261 and beams 262 of the second tier as shown in FIG. 31, the columns 261 and beams of the first and second tiers are attached to each other (e.g., via fasteners, welding, etc.)

In some embodiments, to facilitate the lowering of the columns 261, which are held in place via the folding supports 241, the folding supports 241 may be opened, thereby releasing the columns 261 of the first tier from the frames 240 and enabling the columns 261 of the first tier to be lowered onto the second tier of the columns 261, followed by the attachment of the columns 261 of the first tier and the columns of the second tier to each other.

In some aspects, the remaining (e.g., third, fourth, fifth, etc.) tiers of columns 261 and beams 262 of the lattice tower 260 are assembled via the lifting assembly 250 by repeating the assembly method described above (and shown in FIGS. 25-31). Once all columns 261 and beams 262 of the system 200 are assembled to form a fully assembled lattice tower 160, a portion of which is shown in FIG. 32, the lifting assembly 250 may be dismantled and removed.

Further, like the lifting assembly 150, the lifting assembly 250 can be provided with a propulsion drive 290 in some embodiments, which can be local or remote and may implemented in the form of a winch that is integrated into, or positioned in proximity to, the lifting assembly 250. The propulsion drive can be hydraulic, chain, screw, etc.

The foregoing detailed description of the embodiments is used to further clearly describe the features and spirit of the present invention. The foregoing description for each embodiment is not intended to limit the scope of the present invention. All kinds of modifications made to the foregoing embodiments and equivalent arrangements should fall within the protected scope of the present invention. Hence, the scope of the present invention should be explained most widely according to the claims described thereafter in connection with the detailed description, and should cover all the possibly equivalent variations and equivalent arrangements.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form described. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for assembling a load-bearing frame of a high-rise structure, the system comprising:
a foundation configured to support the load-bearing frame;
a plurality of columns, wherein at least one column of the plurality of columns is connected with an adjacent column of the plurality of columns via at least one beam;
a lifting assembly for coupling to and lifting the plurality of columns, the lifting assembly comprising plurality of posts; and
a fixture rigidly connected to the foundation and configured to anchor the plurality of columns during assembly of the load-bearing frame;
wherein the lifting assembly vertically displaces the plurality of columns to thereby allow placement onto the lifting assembly of an additional plurality of columns under the vertically displaced plurality of columns.

2. The system according to claim 1, wherein the lifting assembly further comprises:
a frame configured to couple to a post of the plurality of posts and to move in a vertical direction along the post;
a plurality of folding supports pivotally attached to the frame and configured to couple to a column of the plurality of columns; and
a plurality of guide rollers that direct the frame along the post.

3. The system according to claim 1, wherein each post of the plurality of posts comprises at least two pulleys.

4. The system according to claim 1, wherein the fixture comprises:
at least one stand for supporting at least one column of the plurality of columns, wherein the stand is fixedly attached to the fixture or movably coupled to the fixture; and
a thrust screw or a support base for level adjustment of the fixture.

5. The system according to claim 1, the high-rise structure is a wind turbine generator.

6. The system according to claim 1, wherein the foundation comprises a plurality of column shoes with a plurality of fasteners for attaching the plurality of posts to the foundation.

7. The system of claim 6, wherein the foundation further comprises a pedestal and the column shoes are coupled to the pedestal.

8. The system of claim 6, wherein the foundation further includes a plurality of support bases for supporting the fixture thereon.

9. The system of claim 8, wherein the support bases further comprise supports positioned to contact the fixture and support the fixture thereon.

10. The system of claim 1, wherein the fixture includes a central hub and a plurality of rail members connected at the central hub, and wherein each of the plurality of posts is movably coupled to a rail member of the plurality of rail members and configured to move between a resting position distal to the central hub and a deployed position proximal to the central hub.

11. The system of claim 2, wherein each of the posts includes at least one wheel to permit the post to move along the fixture while the post is coupled to the fixture, and wherein the frame includes at least one wheel to permit the frame to move in the vertical direction along the post while the frame is coupled to the post.

12. A method for assembling a load-bearing frame of a high-rise structure, the method comprising:
providing a foundation configured to support the load-bearing frame;
providing a lifting assembly for coupling to and lifting a plurality of columns, the lifting assembly comprising a plurality of posts,
connecting the posts of the plurality of posts with the foundation via a plurality of fasteners;
providing a fixture rigidly connected to the foundation and configured to anchor a plurality of columns during assembly of the load-bearing frame;
providing the plurality of columns, wherein at least one column of the plurality of columns is connected with an adjacent column of the plurality of columns via at least one beam; and
vertically displacing the plurality of columns via the lifting assembly to allow placement of an additional plurality of columns onto the lifting assembly and under the vertically displaced plurality of columns.

13. The method according to claim 12, wherein the lifting assembly further comprises:
a frame configured to couple to a post of the plurality of posts and to move in a vertical direction along the post;
a plurality of folding supports pivotally attached to the frame and configured to couple to a column of the plurality of columns; and
a plurality of guide rollers that direct the frame along the post.

14. The method according to claim 12, wherein each post of the plurality of posts comprises at least two pulleys.

15. The method according to claim 12, wherein the fixture comprises:
at least one stand for supporting at least one column of the plurality of columns, wherein the stand is fixedly attached to the fixture or movably coupled to the fixture; and
a thrust screw or a support base for level adjustment of the fixture.

16. The method according to claim 12, the high-rise structure is a wind turbine generator.

17. The method according to claim 12, wherein the foundation comprises a plurality of column shoes with a plurality of fasteners for attaching the plurality of posts to the foundation.

18. The method of claim 12, wherein the fixture includes a central hub and a plurality of rail members connected at the central hub, and wherein each of the plurality of posts is movably coupled to a rail member of the plurality of rail members and configured to move between a resting position distal to the central hub and a deployed position proximal to the central hub.

19. A tier-based system for assembling a load-bearing frame of a high-rise structure, the system comprising:
a first tier including:
a plurality of columns, at least one column of the plurality of columns configured to be connected with an adjacent column of the plurality of columns via at least one beam; and
a lifting assembly, wherein the lifting assembly vertically displaces the plurality of columns to allow placement of an additional plurality of columns under the vertically displaced plurality of columns.

20. The system of claim 19, wherein the lifting assembly includes a fixture including a central hub, a plurality of posts coupled to the fixture, and at least one frame coupled to the plurality of posts and configured to couple to the columns of the first tier and to move in a vertical direction along the posts to vertically displace the columns of the first tier.
